(19) United States
(12) Patent Application Publication
(10) Pub. No.: US 2025/0154032 A1
(43) Pub. Date: May 15, 2025

(54) COAGULATION CONTROL METHOD AND SYSTEM

(71) Applicant: USALCO, LLC, Baltimore, MD (US)

(72) Inventor: Hector L. COLON, Garrochales, PR (US)

(21) Appl. No.: 18/943,153

(22) Filed: Nov. 11, 2024

Related U.S. Application Data
(60) Provisional application No. 63/548,021, filed on Nov. 10, 2023.

(51) Int. Cl. C02F 1/52

(52) U.S. Cl. CPC C02F 1/5209; C02F 2209/003; C02F 2209/006; C02F 2209/06; C02F 2209/11; C02F 2209/20; C02F 2209/28; C02F 2209/40

(57) ABSTRACT

A method of automatically controlling contaminant coagulation includes receiving, by a controller, measurement signals from a plurality of sensors including a turbidity meter that measures turbidity upstream of a coagulation tank, a first spectrophotometer that measures light absorbance upstream of the coagulation tank, a pH meter that measures a pH upstream of the coagulation tank, a temperature probe that measures a temperature upstream of the coagulation tank, a second spectrophotometer that measures light absorbance downstream of a sedimentation tank, and a trihalomethane (THM) sensor that measures a THM level downstream of the sedimentation tank. The controller determines, based at least on the measurement signals from the sensors, a coagulant dose to be administered to the fluid stream in the coagulation tank to obtain a contaminant level below a predetermined threshold value, and causes the determined coagulant dose to be administered to the fluid stream at the coagulation tank.

### CROSS-REFERENCE TO RELATED APPLICATIONS

This application claims the benefit of U.S. Provisional Patent Application No. 63/548,021, filed on Nov. 10, 2023, entitled “Coagulation Control Method and System,” currently pending, the entire contents of which are incorporated by reference herein.

### BACKGROUND

Embodiments described herein relate generally to methods and systems for controlling chemical dosing of one or more coagulants in a fluid treatment system, and more particularly, to such methods and systems that incorporate downstream trihalomethane (THM) measurements as part of an automated coagulant control.

Currently fluid treatment facilities, such as water treatment plants, can utilize automated coagulant dosing systems for controlling coagulant chemical usage to treat fluid streams. Such systems receive data from several sensors and use that data to make corrections and/or adjustments to the amount of coagulants being injected into the fluid stream. However, such systems are lacking in accuracy and predictability as some of the data is used as a surrogate for certain fluid conditions.

It is therefore desired to provide a more reliable and accurate system and method for automatically controlling coagulants in a fluid stream being treated and which are capable of meeting increasing demands for lower contamination.

### BRIEF SUMMARY

Briefly stated, one embodiment comprises a method of automatically controlling coagulation of contaminants in a fluid stream that is treated through a coagulation tank, a flocculation tank, and a sedimentation tank. The method includes receiving, by a controller, a set of measurement signals from each of a plurality of sensors. The plurality of sensors include a turbidity meter configured to measure turbidity of the fluid stream at a position upstream of the coagulation tank, a first spectrophotometer configured to measure an absorbance of light at one or more predetermined wavelengths by the fluid stream at a position upstream of the coagulation tank, a pH meter configured to measure a pH of the fluid stream at a position upstream of the coagulation tank, a temperature probe configured to measure a temperature of the fluid stream at a position upstream of the coagulation tank, a second spectrophotometer configured to measure an absorbance of light at one or more predetermined wavelengths by the fluid stream at a position downstream of the sedimentation tank, and a trihalomethane (THM) sensor configured to measure a THM level in the fluid stream at a position downstream of the sedimentation tank. The method further includes determining, by the controller, based at least on the set of measurement signals from the plurality of sensors, a coagulant dose to be administered to the fluid stream in the coagulation tank to obtain a contaminant level below a predetermined threshold value, and causing, by the controller, the determined coagulant dose to be administered to the fluid stream at the coagulation tank.

In one aspect, determining, by the controller, of the coagulant dose to be administered includes multiplying each of the measurement signals by a respective parameter coefficient. In another aspect, each respective parameter coefficient is set based at least on historical data collected from the plurality of sensors.

In yet another aspect, determining, by the controller, of the coagulant dose to be administered includes comparison with an ideal dosing curve. In another aspect, the ideal dosing curve is based on a statistical regression analysis using at least historical data collected from the plurality of sensors.

In a further aspect, the fluid stream is further treated via filtration downstream of the sedimentation tank, the position for measuring by the second spectrophotometer is downstream of the filtration of the fluid stream.

In a still further aspect, the fluid stream is further treated via disinfectant downstream of the sedimentation tank, the position for measuring the THM level by the THM sensor is downstream of the disinfection of the fluid stream.

In still another aspect, the method further includes estimating, by the controller, an amount of total organic carbon (TOC) based at least on the set of measurement signals from the first spectrophotometer and the second spectrophotometer.

In a yet further aspect, the method further includes receiving, by the controller, a set of measurement signals from each of: a fluid flow meter configured to measure incoming flow of the fluid stream at a position upstream of the coagulation tank, and at least one dosing flow meter configured to measure incoming flow of coagulant between the coagulation tank and at least one dosing pump providing the coagulant to the coagulation tank. The determining, by the controller, of the coagulant dose to be administered is further based on the set of measurement signals from the fluid flow meter and the at least one dosing flow meter.

### BRIEF DESCRIPTION OF THE SEVERAL VIEWS OF THE DRAWINGS

The following detailed description of preferred embodiments will be better understood when read in conjunction with the appended drawings. For the purpose of illustration, there are shown in the drawings embodiments which are presently preferred. It should be understood, however, that the invention is not limited to the precise arrangements and instrumentalities shown.

In the drawings:

FIG. 1 is a schematic block diagram of a fluid treatment system implementing an example of a coagulation control method and system in accordance with the invention;

FIG. 2 is a schematic block diagram of an example streaming current control system that may be deployed within the fluid treatment system of FIG. 1; and

FIG. 3 is a screenshot of an interface screen for use with the fluid treatment system of FIG. 1.

### DETAILED DESCRIPTION

Certain terminology is used in the following description for convenience only and is not limiting. The words “right”, “left”, “lower”, and “upper” designate directions in the drawings to which reference is made. The words “inwardly” and “outwardly” refer to directions toward and away from, respectively, the geometric center of the device and designated parts thereof. The terminology includes the above-listed words, derivatives thereof, and words of similar import. Additionally, the words “a” and “an”, as used in the claims and in the corresponding portions of the specification, mean “at least one.”

It should also be understood that the terms “about,” “approximately,” “generally,” “substantially” and like terms, used herein when referring to a dimension or characteristic of a component, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

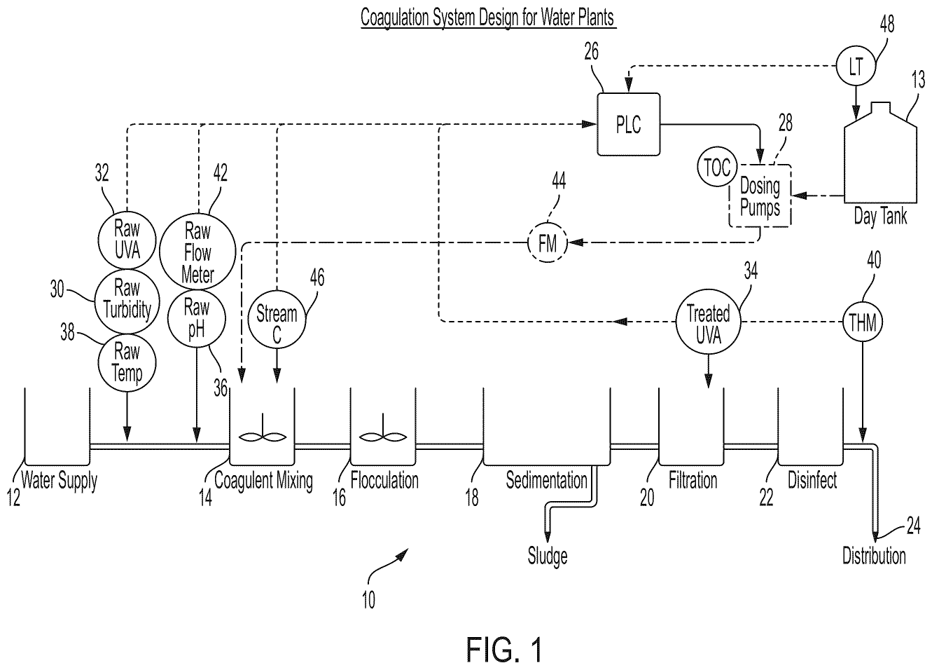

Referring to FIG. 1, there is shown an example fluid treatment system 10 within which a coagulation control method and system according to embodiments disclosed herein may be implemented. The fluid treatment system 10 may be a system for water or wastewater treatment, although the embodiments described herein may be utilized for other types of fluids. The fluid treatment system 10 may include a fluid source 12, which may be a natural or artificial source of water or other fluid, such as a river or stream, lake, supply tank, reservoir, sewage outlet, combinations thereof, or the like.

A fluid stream may be provided by the fluid source 12 for treatment through a coagulation tank 14, a flocculation tank 16, and a sedimentation tank 18, as is conventionally known. A coagulant dose may be administered to the fluid stream at the coagulant tank 14 (e.g., the coagulant may be added to the fluid within the coagulation tank 14, injected into the fluid stream upstream of the coagulation tank 14, or the like. After exiting the sedimentation tank 18, the fluid stream may optionally enter one or more filtration systems 20. After filtration 20, the fluid stream may enter disinfection 22, where one or more disinfectants may be provided and mixed with the fluid stream. Disinfection 22 may take place in a discrete basin, in line with the fluid stream, combinations thereof, or the like. The fluid stream may thereafter be routed to distribution 24, such as a fresh water supply, as an example. Other processes may be implemented upon the fluid stream within the fluid treatment system 10, including injection of other additives, performance of other mechanical processes, and the like, as needed.

For controlling coagulation of contaminants in the fluid stream of the fluid treatment system 10, a controller 26 may be provided. The controller 26 may be a programmable logic controller (PLC), but may also be a microcontroller unit (MCU), a central processing unit (CPU), a microprocessor, an application specific controller (ASIC), a programmable logic array (PLA), combinations thereof, or the like. The controller 26 may include or be coupled to a memory (not shown) that may store code or software for carrying out processes described herein and/or carrying out other operations within the fluid treatment system 10 and may store data for later analysis or transfer to remote or external devices. It should be further appreciated that although the controller 26 in the example of FIG. 1 is a single component, the controller 26 may include a plurality of individual devices, with control functions divided among the individual devices. The controller 26 may also be located on premises of the fluid treatment system 10, remotely, or distributed both locally and remotely.

The controller 26 may be in wired (e.g., USB, Ethernet, IEEE 1394, or the like) or wireless (e.g., BLUETOOTH, WI-FI, ZIGBEE, Z-WAVE, 3G, 4G, or 5G cellular, infrared, or the like) communication with a plurality of sensors distributed within the fluid treatment system 10. The controller 26 may utilize measurement signals received from one or more of the sensors for determining conditions within the fluid treatment system 10 and/or causing one or more components in the fluid treatment system 10 to take particular actions.

The sensors may include a turbidity meter 30 that may be configured to measure turbidity of the fluid stream at a position upstream of the coagulation tank 14. The controller 26 may therefore receive turbidity data of the fluid stream as received from the fluid supply 12 prior to any actions taken by the fluid treatment system 10. However, additional turbidity meters (not shown) may be positioned elsewhere along the fluid stream and may similarly report turbidity data to the controller 26, as desired.

The sensors may also include a first spectrophotometer 32 that is configured to measure, at a position upstream of the coagulation tank 14, an absorbance, by the fluid stream, of light having one or more predetermined wavelengths. In particular, the first spectrophotometer 32 may be configured to measure absorbance of 254 nm light (UVA254), which is a standard for water quality testing, the results of which may be correlated to organic carbon, color, disinfection byproduct precursors, and the like. However, additional or alternative light wavelengths may be used as well. The controller 26 may therefore receive absorbance data of the fluid stream as received from the fluid supply 12 prior to any actions being taken by the fluid treatment system 10.

The sensors may also include a second spectrophotometer 34 that is configured to measure, at a position downstream of the sedimentation tank 18, an absorbance, by the fluid stream, of light at one or more predetermined wavelengths. Like the first spectrophotometer 32, the second spectrophotometer 34 may be configured to measure absorbance of 254 nm light, although additional or alternative wavelengths may be used as well. The controller 26 may therefore receive absorbance data of the fluid stream following mixing of the coagulant, flocculation, and sedimentation. In the particular example shown in FIG. 1, the second spectrophotometer 34 is positioned downstream of the filtration 20 as well. Additional spectrophotometers (not shown) may be positioned elsewhere along the fluid stream and may similarly report absorbance data for one or more light wavelengths to the controller 26, as desired.

The sensors may also include a pH meter 36 that is configured to measure a pH of the fluid stream at a position upstream of the coagulation tank 14. The controller 26 may therefore receive pH data of the fluid stream as received from the fluid supply 12 prior to any actions being taken by the fluid treatment system 10. However, additional pH meters (not shown) may be positioned elsewhere along the fluid stream and may similarly report pH data to the controller 26, as desired.

The sensors may also include a temperature probe 38 that is configured to measure a temperature of the fluid stream at a position upstream of the coagulation tank 14. The controller 26 may therefore receive temperature data of the fluid stream as received from the fluid supply 12 prior to any actions being taken by the fluid treatment system 10. However, additional temperature probes (not shown) may be positioned elsewhere along the fluid stream and may similarly report temperature data to the controller 26, as desired.

The sensors may also include a THM sensor 40 that is configured to measure a THM level in the fluid stream at a position downstream of the sedimentation tank 18. THMs are a byproduct of treatment when organic material reacts with chemicals used to treat the fluid, such as chlorine. The controller 26 may therefore receive THM data of the fluid stream following mixing of the coagulant, flocculation, and sedimentation. In the particular example shown in FIG. 1, the THM sensor 40 is positioned to measure THM levels of fluid ready for distribution 24, such as downstream of the disinfection 22. Additional THM sensors (not shown) may be positioned elsewhere along the fluid stream and may similarly report THM level data to the controller 26, as desired.

The sensors may also include a fluid flow meter 42 that is configured to measure an incoming flow rate of the fluid stream at a position upstream of the coagulation tank 14. The controller 26 may therefore receive data related to the flow rate of the fluid stream incoming from the fluid supply 12. However, additional fluid flow meters (not shown) may be positioned elsewhere along the fluid stream and may similarly report flow rate data to the controller 26, as desired.

The sensors may also include at least one dosing flow meter 44 that is configured to measure an incoming flow rate of coagulant between the coagulation tank 14 and at least one dosing pump 28 providing the coagulant to the coagulation tank 14. Chemical coagulant(s) may be stored in one or more chemical tanks 13 within the fluid treatment system 10. The tank(s) 13 may be connected to one or more dosing pumps 28 used to move the coagulant(s) from the chemical tank(s) 13 and into the coagulation tank 14 to mix with the fluid stream. The controller 26 may therefore receive data from the one or more flow meters 44 related to the flow rate of coagulant directed toward the coagulation tank 14. The dosing pump(s) 28 may be operated by the controller 26 to control coagulant dosing according to methods described herein.

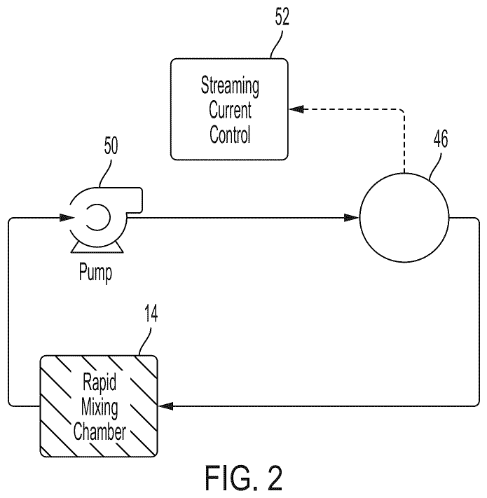

The sensors may also include a streaming current meter 46 that is configured to detect the presence of charged ions moving in the fluid stream at a location within or downstream of the coagulation tank 14. FIG. 2 illustrates an example embodiment where the streaming current meter 46 operates on a sample stream continuously withdrawn from the coagulation tank 14. A sampling pump 50 may be provided to withdraw fluid from the coagulation tank 14 that has been treated with the coagulant(s). The sampling pump 50 may direct the sample stream toward the streaming current meter 46, which measures the electrical charge within the sample stream. After passing through the streaming current meter 46, the sample stream may be diverted back to the coagulation tank 14. The electrical charge measurements from the streaming current meter 46 may be used by a streaming current control 52, which may be a program executed by the controller 26 or may be a separate controller device in communication with the controller 26, to adjust chemical dosing as needed to address variations in the streaming current. In alternative embodiments, the streaming current meter 46 may act directly on the fluid stream, such as downstream of the coagulation tank 14 or in other similar locations, to obtain streaming current readings.

Referring again to FIG. 1, the sensors may also include one or more level transmitters 48 that are configured to measure levels in the chemical tank(s) 13, which may be communicated to the controller 26. The controller 26 may be able to alert an operator, or transmit alerts to another controller or computing device in the fluid treatment system 10, if levels in one or more of the chemical tanks 13 have dropped below a threshold and require replenishment.

Other sensors (not shown) that may be utilized within the fluid treatment system 10 configured for obtaining data potentially relevant to coagulant dosing may also be in communication with the controller 26, as desired.

The controller 26 may use data from various sensors 26 to determine a coagulant dose to be administered to the fluid stream in the coagulation tank 14 to obtain a contaminant level below a predetermined threshold value. For example, the controller 26 may determine that an adjustment is needed to the current coagulant dose in order to reduce the contaminant level. In another example, the controller 26 may determine that the current coagulation dose is sufficient to maintain the contaminant level within an acceptable range and that no adjustment is necessary. Once the appropriate coagulant dose is determined, the controller 26 may cause that dosage to be administered to the fluid stream at the coagulation tank 14, such as by maintaining or adjusting parameters of the one or more dosing pumps 28 or the like.

The exact relation of sensor data to coagulant dosage may vary from system to system as it may be dependent upon multiple factors, including the equipment within the fluid treatment system 10 and other variables. Accordingly, it is contemplated that the controller 26 may base its determination, at least in part, on historical data collected from the sensors and their correlation to coagulant dosages. The historical data may be collected or at least stored by the controller 26 in internal memory, or may be stored in an externally-supplied memory (not shown), including semiconductor memory device (e.g., a RAM, ROM, PROM, EEPROM, Flash-Programmable RAM, or the like), a magnetic memory device (e.g., a diskette, fixed disk, or the like), an optical memory device (e.g., a DVD-ROM or the like), a PC card (e.g., PCMCIA card or the like), or other memory device. Data collected from the sensors by the controller 26 may be periodically or continuously stored for updating historical data, if needed.

In some embodiments, the coagulant dose may be determined by, in part, multiplying measurement signals received from various ones of the sensors by respective parameter coefficients. For example, one method to determine a coagulant dose CD may be to use the following equation (1):

$$CD = {PPM}_{Cur} + ( Turb \times {C}_{Turb} ) + ( {ABS}_{RF} \times {C}_{ARF} ) + ( {ABS}_{TF} \times {C}_{ATF} ) + ( ( {pH}_{I} - {pH}_{RF} ) \times {C}_{pH} ) + ( ( {T}_{RF} - {T}_{I} ) \times {C}_{T} ) + ( THM \times {C}_{THM} ) \qquad ( 1 )$$

wherein PPM_{Cur} is a current contaminant level, Turb is the measured turbidity of the fluid stream upstream of the coagulation tank 14, C_{Turb} is a turbidity coefficient, ABS_{RF} is the measured absorbance of the raw fluid from the first spectrophotometer 32 upstream of the coagulation tank 14, C_{ARF} is a raw fluid absorbance coefficient, ABS_{TF} is the measured absorbance of the treated fluid from the second spectrophotometer 34 downstream of the sedimentation tank 18, C_{ATF} is a treated fluid absorbance coefficient, pH_{I} is an ideal pH level for the fluid stream, pH_{RF} is the measured pH of the raw fluid stream upstream of the coagulation tank 14, C_{pH} is a pH coefficient, T_{RF} is the measured temperature of the raw fluid stream upstream of the coagulation tank 14, T_{I} is an ideal temperature for the fluid stream, CT is a temperature coefficient, THM is the measured THM level in the fluid stream downstream of the sedimentation tank 18, and C_{THM} is a THM coefficient. The coefficients may be based at least on the historical data collected from the plurality of sensors or otherwise previously collected from the system 10, and so are tuned to deliver an optimal coagulant dose CD given the system conditions.

The current contaminant level PPM_{Cur} may be measured or derived from sensor data, may be a predetermined or previously selected setpoint, combinations thereof, or the like. In one example, the controller 26 may determine the current contaminant level PPM_{Cur} based on measurements from the fluid flow meter 42 and the one or more dosing flow meters 44. However, other methods may be used as well.

In addition to or in place of the use of individual coefficients for determining the coagulant dose to be administered, the controller 26 may compare the current coagulant dosage with an ideal dosing curve based on the currently measured conditions from the plurality of sensors. For example, the ideal dosing curve may be based on a statistical regression analysis (e.g., linear, logarithmic, polynomial, combinations thereof, or the like) using at least historical data collected from the plurality of sensors or otherwise previously obtained from the system 10. However, other methods for determining the coagulant dose to be administered from the above-described measurement data may be used as well.

In some embodiments, the controller 26 may also estimate total organic carbon (TOC) levels using the measurement data from at least the first and second spectrophotometers 32, 34. The TOC determination can be used by the controller 26 to make further coagulant dose changes, as well as assist with adjustments to correct the streaming current.

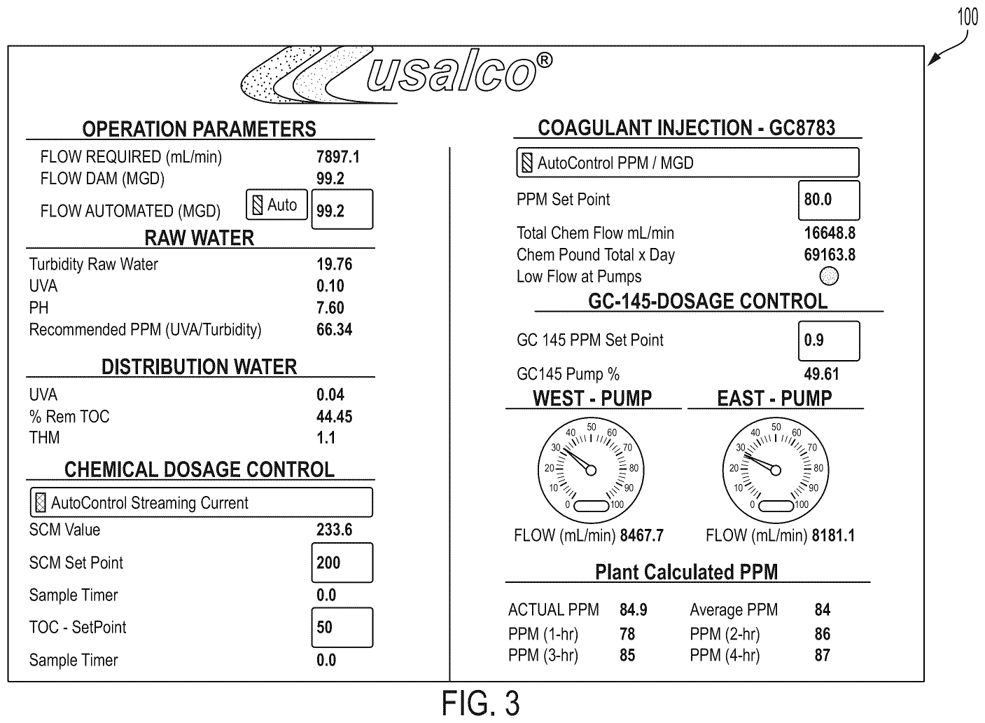

Operators may interact with the fluid treatment system 10 to access, monitor, and/or control various aspects thereof using an interface, such as a touchscreen, one or more screens with associated keyboard, keypad, buttons, dials, and/or other input device(s), combinations thereof, or the like. FIG. 3 is an example screenshot of an interface screen 100 for operator access to values and alarms for the fluid treatment system 10. For example, the interface screen 100 in FIG. 3 provides readouts from the turbidity meter 30, first spectrophotometer 32, and pH meter 36 in the raw fluid stream and readouts from the second spectrophotometer 34 and the THM sensor 40 in the treated fluid stream, among other values including flow and flow rates, TOC, contaminant levels, and the like. The interface screen 100 also allows for selection of automated or manual control of various aspects of the system 10. For example, automated control of streaming current is illustrated by the interface screen 100 with setpoints entered for desired streaming current and TOC levels. Automated control is also illustrated for coagulant injection with specific coagulant levels specified. Visual, audible, and/or tactile alarms may be triggered to alert the operator as to various conditions when flow, contaminant, variable, and/or coagulant levels exceed or drop below established thresholds.

Although a dedicated controller 26 has been shown for control of coagulants in the fluid treatment system, the controller 26 may also be part of a larger controller or controllers operating other aspects of the fluid treatment system 10, including tank or valve operations or the like.

While specific and distinct embodiments have been shown in the drawings, various individual elements or combinations of elements from the different embodiments may be combined with one another while in keeping with the spirit and scope of the invention. Thus, an individual feature described herein only with respect to one embodiment should not be construed as being incompatible with other embodiments described herein or otherwise encompassed by the invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method of automatically controlling coagulation of contaminants in a fluid stream that is treated through a coagulation tank, a flocculation tank, and a sedimentation tank, the method comprising:
receiving, by a controller, a set of measurement signals from each of a plurality of sensors, the plurality of sensors including:
a turbidity meter configured to measure turbidity of the fluid stream at a position upstream of the coagulation tank,
a first spectrophotometer configured to measure an absorbance of light at one or more predetermined wavelengths by the fluid stream at a position upstream of the coagulation tank,
a pH meter configured to measure a pH of the fluid stream at a position upstream of the coagulation tank,
a temperature probe configured to measure a temperature of the fluid stream at a position upstream of the coagulation tank,
a second spectrophotometer configured to measure an absorbance of light at one or more predetermined wavelengths by the fluid stream at a position downstream of the sedimentation tank, and
a trihalomethane (THM) sensor configured to measure a THM level in the fluid stream at a position downstream of the sedimentation tank;
determining, by the controller, based at least on the set of measurement signals from the plurality of sensors, a coagulant dose to be administered to the fluid stream in the coagulation tank to obtain a contaminant level below a predetermined threshold value; and
causing, by the controller, the determined coagulant dose to be administered to the fluid stream at the coagulation tank.

2. The method of claim 1, wherein the determining, by the controller, of the coagulant dose to be administered includes multiplying each of the measurement signals by a respective parameter coefficient.

3. The method of claim 2, wherein each respective parameter coefficient is set based at least on historical data collected from the plurality of sensors

4. The method of claim 1, wherein the determining, by the controller, of the coagulant dose to be administered includes comparison with an ideal dosing curve.

5. The method of claim 4, wherein the ideal dosing curve is based on a statistical regression analysis using at least historical data collected from the plurality of sensors.

6. The method of claim 1, wherein the fluid stream is further treated via filtration downstream of the sedimentation tank, the position for measuring by the second spectrophotometer is downstream of the filtration of the fluid stream.

7. The method of claim 1, wherein the fluid stream is further treated via disinfectant downstream of the sedimentation tank, the position for measuring the THM level by the THM sensor is downstream of the disinfection of the fluid stream.

8. The method of claim 1, further comprising estimating, by the controller, an amount of total organic carbon (TOC) based at least on the set of measurement signals from the first spectrophotometer and the second spectrophotometer.

9. The method of claim 1, further comprising:
receiving, by the controller, a set of measurement signals from each of:
a fluid flow meter configured to measure incoming flow of the fluid stream at a position upstream of the coagulation tank, and
at least one dosing flow meter configured to measure incoming flow of coagulant between the coagulation tank and at least one dosing pump providing the coagulant to the coagulation tank,
wherein the determining, by the controller, of the coagulant dose to be administered is further based on the set of measurement signals from the fluid flow meter and the at least one dosing flow meter.
